(19) United States
(12) Patent Application Publication
(10) Pub. No.: US 2012/0096858 A1
(43) Pub. Date: Apr. 26, 2012

(54) HEATER HEAD FOR ENERGY CONVERTER

(75) Inventors: John E. Augenblick, Richland, WA (US); Rocco Luongo, Richland, WA (US); Justin Thurgood, Pasco, WA (US); Allen Peterson, Kennewick, WA (US); Patrick Fox, Richland, WA (US); Bradley T. Stiles, Richland, WA (US)

(73) Assignee: INFINIA CORPORATION, Kennewick, WA (US)

(21) Appl. No.: 13/250,229

(22) Filed: Sep. 30, 2011

Related U.S. Application Data
(60) Provisional application No. 61/388,936, filed on Oct. 1, 2010.

(51) Int. Cl. F03G 6/00; B23P 17/00

(52) U.S. Cl. 60/641.8; 29/888

(57) ABSTRACT

In part, the invention relates to a heater head that includes a heat absorber plate that forms a substantially concave surface and a manifold comprising a headwall for engaging a heat engine, the manifold forming a concave depression for receiving the heat absorber plate. In various embodiments, the manifold forming a plurality of fluid channels to carry fluid between the heat absorber plate and the heat engine. The heater is suitable for use with energy converting devices, such as Sterling engines.

### CROSS REFERENCE TO RELATED APPLICATIONS

This application claims priority to and the benefit of U.S. Provisional Patent Application No. 61/388,936, filed on Oct. 1, 2010, the disclosure of which is herein incorporated by reference in its entirety.

### FIELD OF THE INVENTION

The invention relates generally to heater heads for use with energy converters.

### BACKGROUND

Certain energy converting apparatuses use a heater head to receive thermal energy from the sun to power an engine cycle such as a Stirling cycle. Under some circumstances, the main failure mode detected in heater heads is creep-fatigue interaction due to primary and secondary loading (pressure and temperature). Replacing a failed heater head can be both time consuming and labor-intensive because the heater head typically is an internal component of an energy converting apparatus. In addition, heater head materials and manufacturing processes are costly.

Heater head failure can be reduced by adding section thickness to reduce the mean stress acting within the material used to form the head. However, increasing material thickness reduces thermal efficiency. Heater head failure also can be mitigated by reducing the engine's operating temperature. However, reducing engine temperature leads to reduced Carnot efficiency and, therefore, reduced system efficiency.

Therefore, a need exists for reducing heater head stresses without compromising energy producing efficiency.

### SUMMARY

In one aspect, the invention relates to a heater head. The heater head includes a heat absorber plate forming a substantially concave surface; and a manifold comprising a headwall for engaging a heat engine, the manifold forming a concave depression for receiving the heat absorber plate, and the manifold forming a plurality of fluid channels to carry fluid between the heat absorber plate and the heat engine. In one embodiment, the heat absorber plate has an arc or radius of between about 1× the outside diameter of regenerator to an infinite spherical radius.

The heater head can be adapted or configured for use with a solar concentrator, and whereby solar rays reflected by the solar concentrator impinge on the surface of the concave heat absorber plate at near right angles. In one embodiment, the shape of the concave surface is configured such that compressive forces applied to the heat absorber plate caused by thermal loading are distributed by the concave shape of the heat absorber plate. In some embodiments, the heater head plate has a thickness that ranges from about 0.040 inches to about 1.160 inches.

In one aspect, the invention relates to a solar energy converting apparatus. The apparatus includes a Stirling engine having one or more pistons and a working fluid; and a heater head having a substantially concave heat receiving surface, the heater head sized to receive light from a concentrator, wherein the heater head is in thermal communication with the Stirling engine. The solar energy converting apparatus can include a plurality of channels disposed opposite to the concave heat receiving surface and a regenerator disposed proximal to and in fluid communication with the channels. In various embodiments, the channels are defined by a manifold, wherein the channels conduct the working fluid between the heater head and the Stirling engine to transfer heat and cause one or more pistons to travel. In some embodiments, the heater head has a bowl shape that is configured to radially distribute compressive stresses resulting from thermal transitions.

In a further aspect, the invention relates to a solar energy converting apparatus. The solar energy converting apparatus includes a concave metal bowl having a curved heat receiving surface and a curved internal surface; and a heater head wall defining a working fluid receiving cavity and a plurality of channels, the channels disposed adjacent to the curved internal surface, the heater head wall having a curved wall surface adjacent the curved internal surface. In one embodiment, the solar energy converting apparatus further includes a regenerator disposed within the cavity, wherein the regenerator is porous such that a working fluid can flow through the regenerator into the plurality of channels. In one embodiment, the curved wall surface defines a manifold defining lengths of the plurality of channels such that the lengths are substantially perpendicular to a portion of the curved wall surface. The plurality of fluid channels can be configured to carry fluid between the heater head wall and a heat receiving element.

In yet another aspect, the invention relates to method of extending the life of a heater head in a solar energy converting apparatus. The method includes the steps of reducing a plurality of failure modes by sizing a heater head relative to a concentrator; and selecting a concave heater head shape such that the concentrator has a convex shape relative to the heater head. In one embodiment, the method further includes the step of positioning the concentrator relative to the concave heater head such that heat losses are reduced due to alignment errors. In some embodiments, the method can include the further step of transferring heat to a working fluid which is in thermal communication with the heater head. In some embodiments, the method can include the step of radially distributing compressive stresses in the heater head resulting from thermal transitions. In some embodiments, the method can include the step of aligning the concentrator and the heater head such that solar rays reflected by the concentrator impinge on a surface of the heater head. In various embodiments, one of the plurality of failure modes is creep fatigue. In various embodiments, one of the plurality of failure modes is metal fatigue.

The aspects and embodiments of the invention described herein are also suitable for use with and combination with the methods, apparatus and systems described in U.S. Pre-Grant Publication No. 2010-0180595, the disclosure of which is incorporated in its entirety herein.

### BRIEF DESCRIPTION OF DRAWINGS

The figures are not necessarily to scale, emphasis instead generally being placed upon illustrative principles. The figures are to be considered illustrative in all aspects and are not intended to limit the invention, the scope of which is defined only by the claims.

FIG. 1 is a schematic diagram of a solar collector or concentrator, in accordance with an illustrative embodiment.

FIG. 2 is a schematic diagram of an energy converting apparatus that includes a Stirling engine and a concave heater head assembly, in accordance with an illustrative embodiment.

FIG. 3 is a top plan view of a concave heater head assembly, in accordance with an illustrative embodiment.

FIG. 4 is a cross-section through plane “A” of the concave heater head shown in FIG. 3, in accordance with an illustrative embodiment.

FIG. 5 is a schematic diagram showing a convex solar concentration and a concave heater head, in accordance with an illustrative embodiment.

FIG. 6 is a schematic diagram showing a cross-section side view of concave heater head connected to a portion of an energy converting apparatus in accordance with an illustrative embodiment.

### DETAILED DESCRIPTION

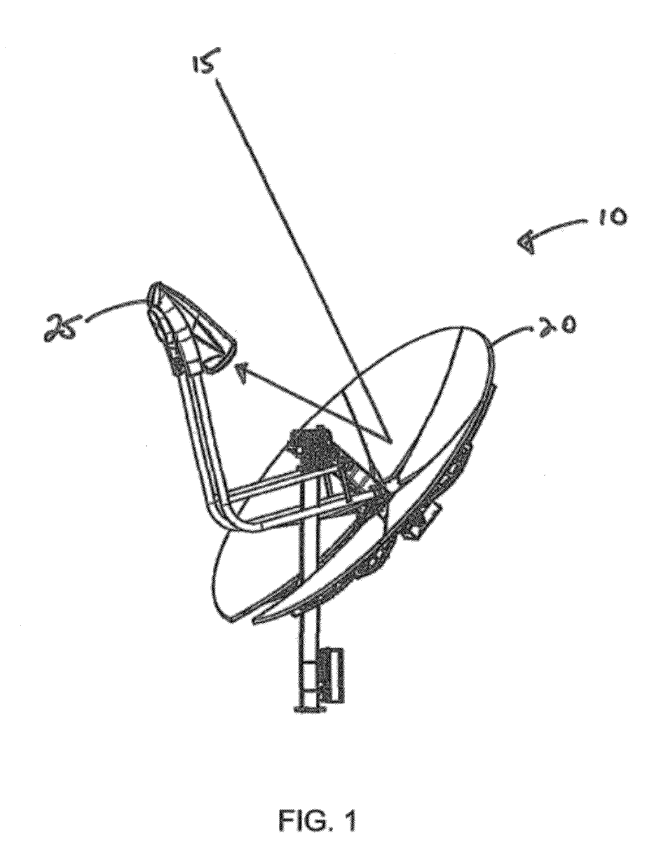

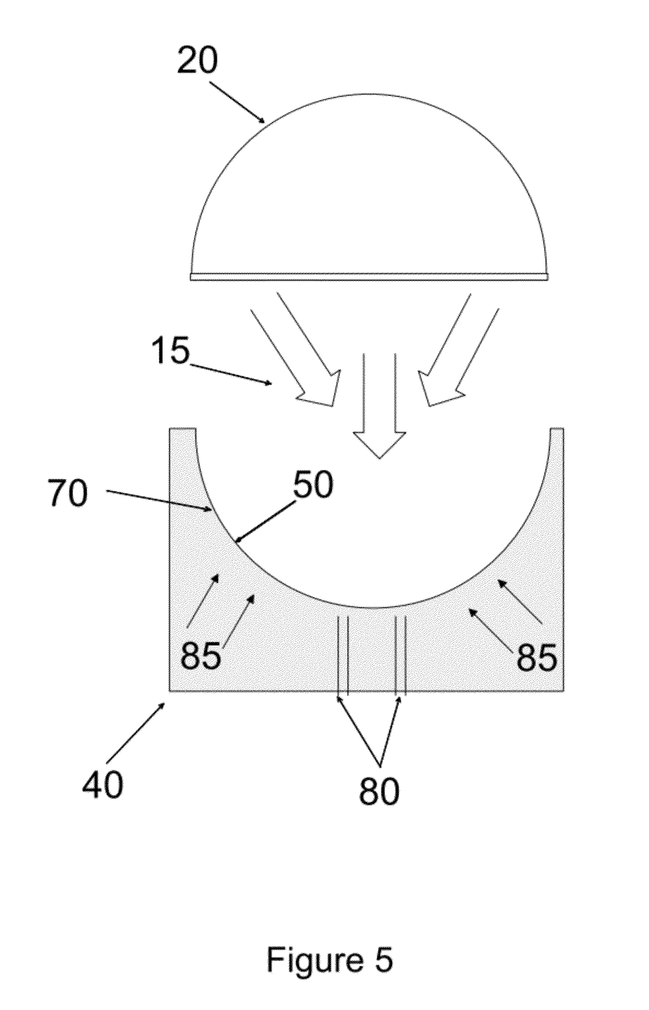

In certain aspects, the invention provides improved heater heads (also known as heat absorbers, heat exchangers, or heater plates) for use with energy converting apparatuses such as those that include Stirling engines. Thermal energy (e.g., solar radiation) is concentrated on a surface of the heater head, causing the temperature of the heater head to increase. The heater head, in turn, is thermally coupled to an energy converting apparatus. For example, such an apparatus may include or be a Stirling engine, which converts thermal energy absorbed by the heater head into another energy type (e.g., electricity). In some preferred embodiments, the heater head has a concave surface (e.g., bowl-shaped surface) onto which the concentrated thermal energy impinges. In one embodiment, the heater head is paired with a convex concentrator (see FIGS. 1 and 5) that directs sunlight onto the surface of the concave heater head.

As discussed in more detail below, the concave shape reduces creep-fatigue, which increases heater head reliability and prolongs the lifespan of the heater head. In addition, the concave shape increases the energy absorption efficiency of the heater head, which results in increased energy production. The selection of a concave heater head also increases the available light-receiving surface relative to that of similarly sized flat heater head. The concave heater head described herein can be radially symmetric such as a portion of sphere or other three dimensional smooth volume or be symmetric along one axis such as a trough.

FIG. 1 is a schematic diagram of a solar energy converting apparatus system or collector 10 for collecting and converting solar radiation. Solar radiation from the sun 15 impinges upon a concentrator 20 (alternatively a dish, array of panels, reflector, or collector) forming a curved surface capable of directing light to an energy converting apparatus 25 (ECA) which includes a heater head.

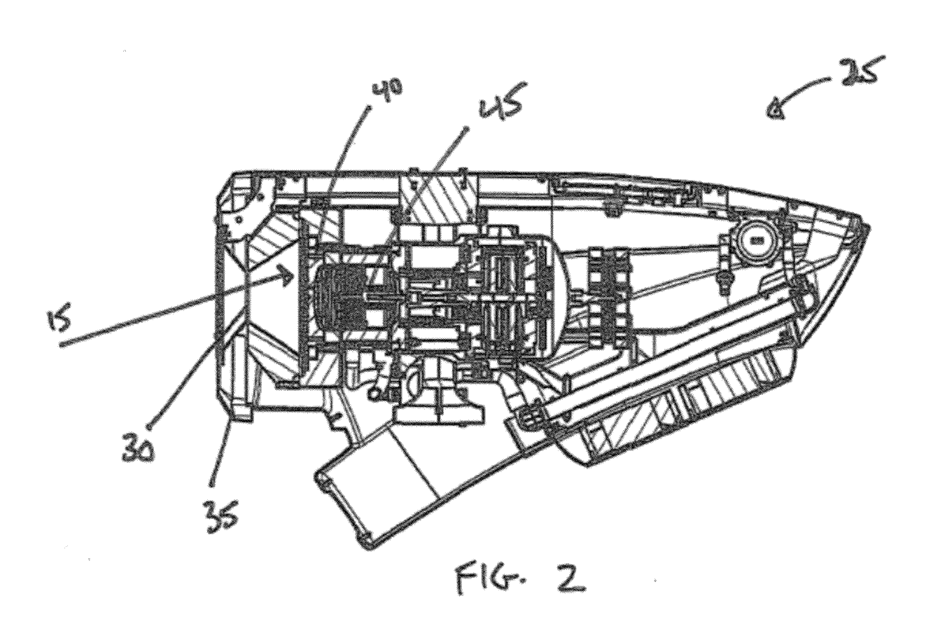

Referring to FIG. 2, an exemplary energy converting apparatus or heat engine 25 is shown having a heater head. The reflected solar radiation 15 enters energy converting apparatus 25 through an aperture 30 in the housing 35 of the apparatus. Solar radiation 15 then impinges on heater head 40, which in one embodiment is thermally coupled to a Stirling engine 45. In one embodiment, the heater head is used with a solar concentrator which as a curvature opposite or the same as that of that heater head. Thus, relative to each other the concentrator and heater head can be concave and convex, respectively, in one embodiment. However, other geometries are possible for the heater head and concentrator. As shown, in FIG. 5, this pairing of concave heater head with a convex concentrator is contrary to general pressure vessel design, such as a tank with one or two hemispherical end caps. This point is discussed in more detail below relative to FIG. 5.

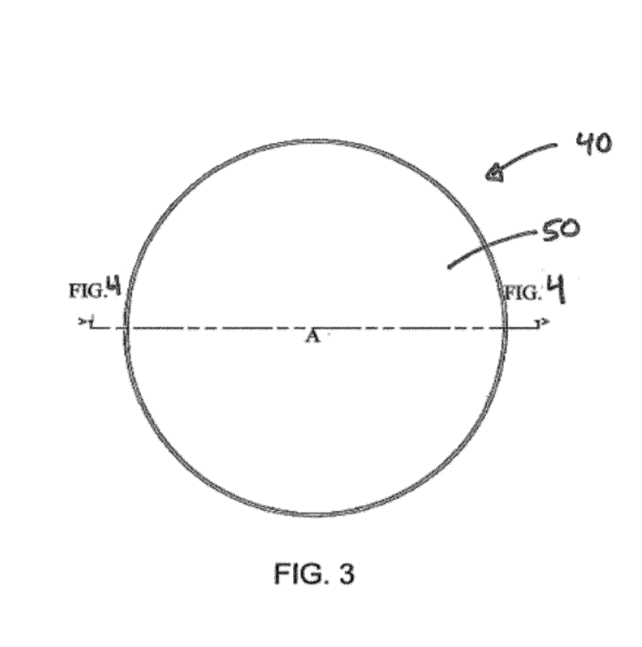

FIG. 3 shows a top plan view of a concave heater head 40 having a concave surface 50. In various embodiments, the heater head has a substantially round profile or bowl shape and is substantially symmetrical.

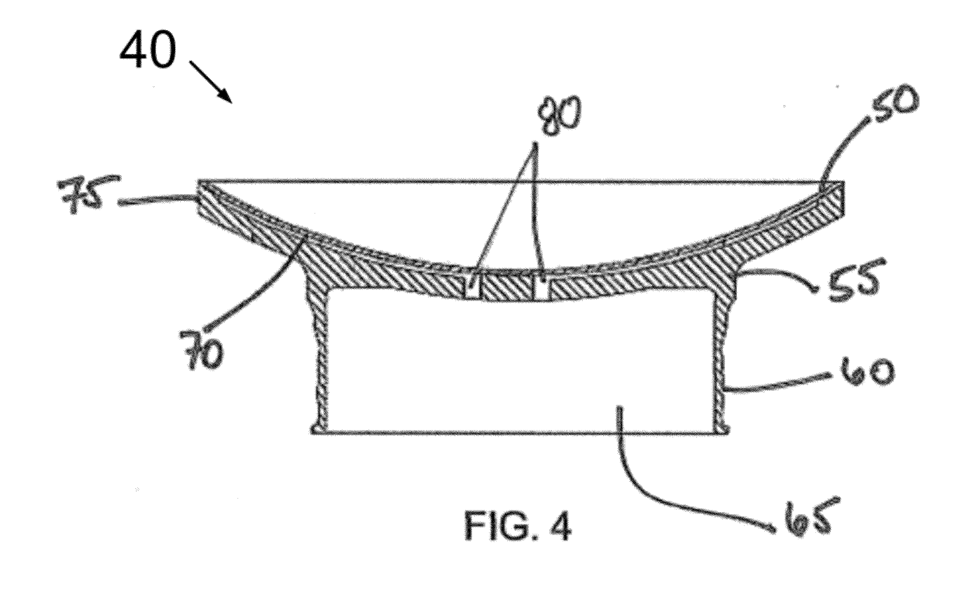

FIG. 4 shows a cross-sectional view of an illustrative concave heater head embodiment through line “A” in FIG. 3. Thermal energy is concentrated on the concave surface 50 of heater head 40. In some embodiments, the concave surface 50 is a substantially concave heat absorber plate which is in thermal communication with a manifold 55. The absorbing surface is the top of the bowl shaped heater head. In some embodiments, it is a two piece assembly that is joined together via hot isostatic pressing (HIP) bonding. In another embodiment, the two pieces are brazed together. HIP bonding is advantageous because it achieves a diffusion bond between the top plate and the machined manifold forging without the use of a braze media which has working fluid channels 80 machined into it after it was formed into a spherical bowl. The top plate is then HIP bonded to the machined manifold forging. This assembly forms the hot heat exchanger 110 for the engine. The assembly has channels and ports 80 machined into the two parts prior to bonding so that the helium working fluid can flow through the heater head and get heated by the sun and then flow to either the expansion space above the displacer assembly or through the regenerator. Thus, the channels 80 provide pressure relative to one side of the heater head, the convex side of the heater head, while sunlight causes thermally induced forces and heatflow on the concave side of the heater head.

Concentrating thermal energy, such as solar radiation, on surface 50 increases the temperature of the heater head manifold 55. Manifold 55 includes a headwall 60 that forms a cavity 65 for engaging and communicating with a heat engine, such as a Stirling engine. Thus, the surface 50 serves as a cap to a pressure vessel formed by cavity 65 and channels 80. Manifold 55 can include a plurality of fluid channels for carrying fluid between the concave surface 40 and the heat engine. Thus, thermal energy is transferred from the heater head 40 to the heat engine. In some embodiments, the concave surface 50 and manifold 55 are integral or unitary.

In general, a heater head is subject to a plurality of failure modes. Since the heater head is under load, there is a metal fatigue component. In addition, since the heater head is subject to high heat from the sun by design, there is a tendency for it to expand, stretch or creep over time. In one embodiment, these two failure modes are referred to as creep-fatigue.

With continued reference to FIG. 4, creep-fatigue failure is addressed by changing the shape of the heater head from flat to slightly concave or bowl-shaped. The concave shape has many benefits. First, pressure is more evenly distributed. Specifically, when pressure is applied to the convex side 70 (i.e., the back side) of the bowl, and the outer edge 75 of the heater head is cooler in temperature than the center of the heater head, compressive stresses are generated throughout the bowl structure. Because creep-fatigue failures are caused by members in tension, creep-fatigue is reduced by the bowl-shape, which radially distributes compressive stresses throughout the heater head. The failure modes of metal fatigue and creep fatigue can result in a reduction in the working life of a solar energy conversion system. As such, reducing these modes is desirable.

In addition, the concave shape is a more efficient structure than a flat heater head because the concave heater head requires less material to carry the same thermal load. As a result, the heater head is thinner, which not only increases thermal transfer efficiency but also reduces the amount of expensive construction materials which are needed to build each heater head.

Moreover, the concave shape more closely approximates the shape of the solar concentrator (see FIGS. 1 and 5). As such, the thermal energy impinging on the surface of the heater head does so at approximately right angles to the surface, reducing what is known as cosine error losses. In one embodiment, cosine error losses are pointing losses that occur because the assembly is not built perfectly and the system does not track the sun perfectly. With the reduction of these losses, thermal energy absorption is improved and system efficiency increases.

FIG. 5 depicts a heater head having 40 a concave surface 50 positioned relative to a convex concentrator 20 such that the heater head receives incident sunlight 15 reflected by the concentrator onto the concave surface 50. This figure illustrates a counter-intuitive feature of the heater head design shown. In one embodiment, the heater head functions as a combination pressure vessel and heat exchanger 110. The heater head 40 receives thermal energy/light 15 from a convex concentrator 20 that impinges on the concave surface 50. The working fluid channels 80 are in communication with a cavity such that they are a source of pressure shown as the internal forces 85 that are applied to the internal side of the heater head 70. In a conventional pressure vessel design, the heater head would be a curved cap, such as those seen at the ends of gas transport tanks. In contrast, in view of the thermal energy and resulting creep fatigue as well as optical and surface area maximization considerations, a concave or bowl shaped heater head is preferred. Again, this is counterintuitive because conventional pressure vessel design would indicate that a flat or convex heater head would be preferred as pressure vessel cap. The concave heater head design results in longer heater head life and a reduction in the negative impact of creep-fatigue. In one embodiment, the shape of the convex concentrator 20 and concave surface 50 are chosen to have a similar or correlated degree of curvature.

In general, the heater had can be any type of concave or bowl shaped curve. In one embodiment, the heater can be a hemisphere of another portion of a sphere, such as for example a bowl formed from a third, a quarter or some other fractional part of a hemisphere. Alternatively, the heater head can be trough shaped such that it symmetric along one axis (or more than one axis. Thus, the concave heater head can be ellipsoidal, parabolic, or another smooth curve or conic section. In a preferred embodiment, the concave heater head is smooth to improve reflections. The heater head can be defined by any suitable polynomial or as a sum of sinusoidal and co-sinusoidal functions consistent with Fourier theory. The heater head, manifolds, plates, and other features are configured to direct forces and reduces thermal stresses and other features as described herein.

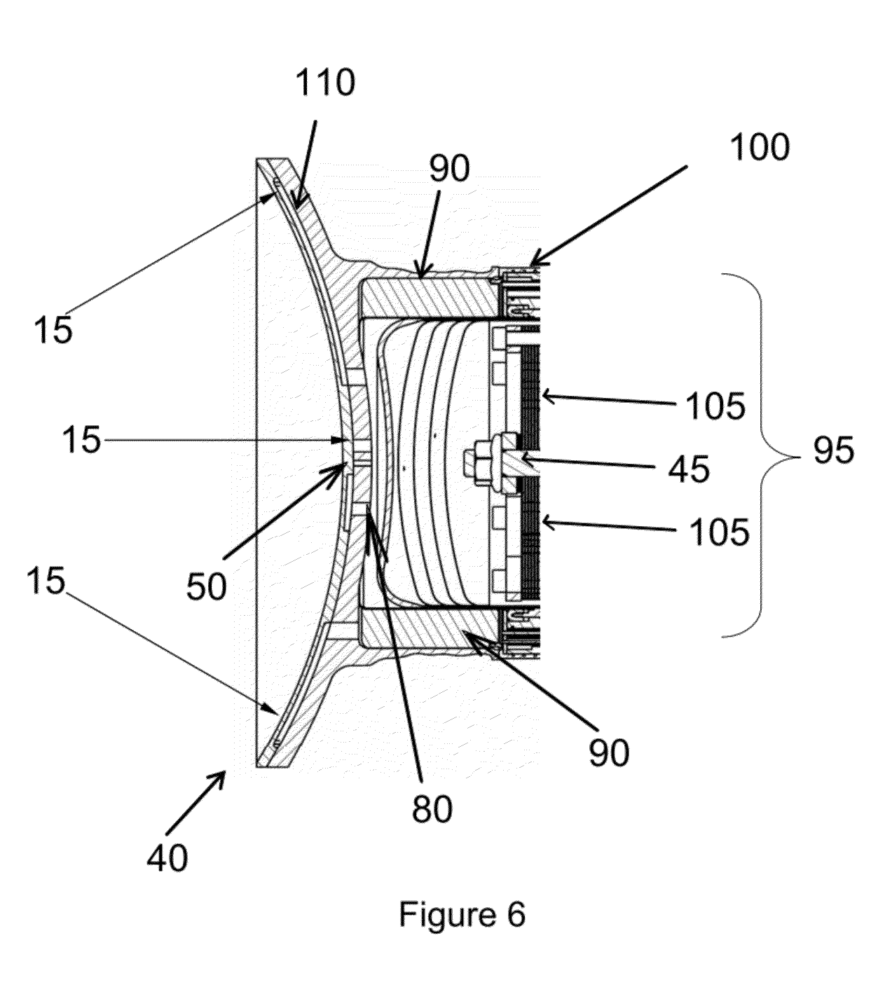

An exemplary concave heater head in thermal communication with a portion of an energy converting apparatus is shown in FIG. 6. Thermal energy 15 impinges on the concave surface 50 of the heater head. This concave surface 50 forms part of a hot heat exchanger that transfers heat to a working fluid in contact with the concave surface 50 via working fluid channels 80. In turn, the channels 80 are in fluid communication with a cavity 65 proximal to a regenerator 90. The regenerator 90 is porous and the working fluid moves through it. Typically, it is formed from small thin fibers. The diameter of the regenerator is RD 95. The regenerator 90 is in communication with a cold heat exchanger 100. A Stirling engine 45 in communication with a piston has components which are supported by a spring 105 as shown. In one embodiment, the curvature of the heater head can be a spherical radius that can be between 1× the diameter of the regenerator outside diameter RD 95 and an infinite radius. Thus, the heater head can be a portion of sphere or another fraction of sphere having a radius equal to RD. In one embodiment, the heater head can be any concave surface suitable for receiving light from a concentrator.

In some embodiments, the heater head is part of an energy converting apparatus mounted relative to a convex solar concentrator, and the curvature of the heater head substantially matches the curvature of the solar concentrator. In one embodiment, the curve shape of the heater head is selected to match that of the concentrator which directs light upon the surface of the heater head. This configuration maximizes the amount of light impinging on the heater head surface at near right angles.

In some embodiments, the surface of the heater head is substantially smooth (i.e., non-textured). In some embodiments, the surface of the heater head is textured. The absorber surface also can be coated or treated to increase heat absorption.

The components of the heater head can be composed of any suitable material that can withstand high thermal temperatures and large thermal gradients in long life design applications. In various embodiments, the top plate is formed and gas flow channels are machined into convex side of the plate. A manifold block is machined to match the spherical radius of the top plate. The manifold block also is machined with integral heater head walls and gas flow ports. This two-piece assembly is then diffusion bonded together using a HIP bonding or brazing method. In some embodiments, these parts are made from solution annealed Inconel® 625 or Haynes® 230 alloys. This particular material choice can be made from a class of metals called super-alloys, high thermal-performance alloys, or any other descriptor of a metal that is designed or is innately inclined to have appropriate structural and heat-transfer performance at a high temperature. In some embodiments, the heater head and cold heat exchanger can be welded or bolted together. In a bolted configuration a bolting flange can be welded to the manifold. This flange can be made from a 300 series stainless steel, such as 304, for ease of machining. One of skill in the art will appreciate that many other suitable materials can be used in accordance with the present teachings.

The top plate can be, for example, between about 0.040 and about 0.160 inches thick and, more preferably, between about 0.080 and about 0.120 inches thick. In some embodiments, the top plate is about 0.120 inches in thickness. The plate can be formed by stamping or machining. In embodiments where the heater head is used with a combustion burner, metal fins can be used as extended surface area to enhance heat transfer between the top plate and the combustion burner. The heat exchanger fins can be formed from sheet metal or can be cast or machined.

In some embodiments, the duty life of the heater head exceeds 60,000 hours. In various embodiments, the heater head can tolerate internal pressures of up to about 1000 psig peak. In addition, the heater head can tolerate a maximum hot side temperature of about 825° C., corresponding to a cold side temperature of about 87° C. (rejection temperature), in various embodiments.

Heater head 40 can be formed from a multi part brazement or HIP bonded structure that includes a manifold, and top plate. The geometry and material selection of the components is important in balancing the operating pressure, operating temperature, longevity, and cost. The architecture of this component allows for the easy adaptation of the Stirling engine, of which it is a component, to any potential heat source, including solar, bio gas, radioisotope, diesel fuel, natural gas, etc.

Heater head architecture, including the concave shape, helps create a heater head surface ideally suited to long-life, mass-producible, multi-market, heat exchanger components. The heater head 40 transfers thermal power from the absorber surface 50 to the engine working fluid via convective heat transfer. The desire to have a high fluid velocity needed to assure sufficient heat exchange must be tempered with minimizing the fluidic back pressure associated with internal tubular flow. The optimization of channel geometry within the one-piece channel plate assures excellent heat transfer with a minimum of flow losses while adequately covering the entire absorbing surface, negating heat transfer dead zones.

In various embodiments of the present teachings, the heater head 40 interfaces with a heat engine, such as, for example, a Stirling engine 45. The heater head 40 transfers thermal energy from a heat source to the heat engine 45. The heater head 40 can interface with any suitable heat source, such as, for example, heat generated from solar energy and/or a combustion burner (e.g., a JP-8 diesel burner).

As will be appreciated, the heater head can be formed from a plurality of components. The components can include a top plate, a manifold block, and a heater head wall. In some embodiments, the individual components can be joined to form an integral heater head.

In some embodiments, the heater head can be formed from a plurality of components that can include one or more sacrificial plates. One or more sacrificial plates can be interpolated between any or all of the components which form the heater head. For example, one or more sacrificial layers can be interpolated between the top plate and the channel plate, one or more sacrificial layers can be interpolated between the channel plate and flow distribution plate, and/or one or more sacrificial layers can be interpolated between the flow distribution plate and the manifold block.

The sacrificial layers can be composed of any suitable low-melting point material or materials, such as a metal alloy. In some embodiments, the individual components can be joined together to form an integral heater head, while the sacrificial layers are substantially converted into platelets or tubes that allow heat exchange through the holes and channels in the final brazed heater head assembly. The sacrificial layers typically include a low melting point metal that liquefies during in the brazing process.

The heater head can include two major subassemblies, a pressure vessel subassembly and a hot heat exchange subassembly. The pressure vessel subassembly can include the cold side flange or a weld interface flange and a manifold block with an integral heater head wall.

The manifold block acts as an end cap for the pressure vessel subassembly. The manifold block is substantially torispherical in shape. The top of the manifold (i.e., the surface which faces the hot heat exchanger) can include an asymmetric hub which facilitates alignment of the manifold block, the top plate. The central hub can have one or more asymmetric notches that are positioned such that it is impossible to align the plates incorrectly. The manifold block can be roughly sized using the ASME boiler and pressure vessel code and then refined using finite element analysis (FEA) modeling. In some embodiments, the manifold block contains porting features to allow for the communication of helium between the expansion space and the compression space by way of the hot heat exchanger. The manifold block can be formed by, for example, machining billet stock or a forging or investment casting.

The heater head wall profile is optimized for structural efficiency and thermal loss reduction. The heater head wall 952 can have a tailored wall profile. The heater head wall can be made from Inconel® 625 or Haynes® 230 by, for example, a flow forming process or by machining. This particular material choice can be made from a class of metals called super-alloys, high thermal-performance alloys, or any other descriptor of a metal that is designed or is innately inclined to have appropriate structural and heat-transfer performance at a high temperature. The heater head wall can be made as an integral part of the manifold block via machining or welded to the manifold block using a laser weld or other suitable welding process. A brazing process is also acceptable.

In some embodiments, the cold side flange provides a mount on the heater head for the heat engine. The cold side flange can be a substantially planar ring. The cold side flange can also have a plurality of holes for reversibly attaching the heater head to the heat engine using, for example, screws or bolts. The cold side flange can be joined to the heater head wall using a braze joint or weld joint, such as an annular seat located on the inside diameter of the cold side flange, which seat is configured to receive the heat head wall. In other embodiments, the cold side flange can be replaced with a bimetallic joint from the aluminum engine housing to the Inconel® heater head. The cold side flange can be milled from either a plate or a casting. The Cold side flange could also be replaced by a weld interface surface allowing the heater head to be joined to its mating component via a welding method.

The displacer cylinder is a thin-walled structure and is used to create the annular cavities which form an expansion space and a regenerator space. In various embodiments, the displacer cylinder is made of Inconel® 625 or Haynes® 230, to minimize stresses caused by differential thermal expansion, which could occur if other materials were used. This particular material choice can be made from a class of metals called super-alloys, high thermal-performance alloys, or any other descriptor of a metal that is designed or is innately inclined to have appropriate structural and heat-transfer performance at a high temperature. The cylinder can be rolled and welded from sheet material and/or can be machined, drawn or flow formed. The cylinder can be brazed into the manifold block. In some embodiments, this is not included this in the heater head assembly, and is welded into the heater head during the engine final assembly step.

The second major subassembly of the heater head is the hot heat exchanger (HHX). In some embodiments, the hot heat exchanger subassembly is formed from a single plate plates that, when joined, form the helium flow passages. This plate includes integral channels that distribute the helium working fluid through the hot heat exchanger, each of which can be made of Inconel® 625 or Haynes® 230. This particular material choice can be made from a class of metals called super-alloys, high thermal-performance alloys, or any other descriptor of a metal that is designed or is innately inclined to have appropriate structural and heat-transfer performance at a high temperature.

In various embodiments, the top plate is the heat-absorbing surface of the hot heat exchanger. The top plate can be substantially disc shaped and/or can be substantially planar. The top plate can have a locating feature in the center of the plate, which receives the central hub of manifold plate, and thereby facilitates alignment of the top plate with the manifold block, the flow distribution plate, and/or the channel plate. In some embodiments, the locating feature can include one or more asymmetric tabs, which are configured to interact with one or more asymmetric notches in the central hub such that the plates cannot be aligned incorrectly.

In various embodiments, the channel plate contains a plurality of arcuate finned channels which radiate from the central region of the channel plate. The channels both expand the available surface area on the helium side of the heat exchanger and direct helium flow across the top plate surface. Channels may be staggered in location allowing for the entire absorbing surface to participate in active heat transfer. The shape of the finned channels can be a substantially elongated S-shape or straight, which shape provides for normal entry into the inside diameter plenum space of the manifold block and the turnaround plenum in the distribution plate, thereby reducing flow losses in those regions.

The components of the heater head can be joined together using one weld and a single inert gas belt braze, vacuum braze or HIP bonding method. In some embodiments, the heater head wall is first welded to the manifold block. The weld can be accomplished by, for example, a single sided, butt-joint, laser weld with a backing plate. Once the manifold block and heat head wall are welded, the remaining components can be stacked and readied for the braze process. In various embodiments, the top plate, the channel plate, and the flow distributor plate can be aligned to the manifold block using a central hub located on the top of the manifold block.

The central hub can have one or more asymmetric notches that are positioned such that it is impossible to align the parts incorrectly. HIP bonding does not require a braze alloy, however if brazing is used A solid ring braze alloy pre-form is placed between each component and covers all surfaces to be brazed. Excess braze may coat the helium flow channels, but will be insufficient to cause blockages. The braze alloy pre-forms can have tabs on their outside diameter that protrude past the outside diameter of the hot heat exchanger to give visual confirmation that braze alloy pre-forms have been inserted. The cold side flange and the displacer cylinder can be fixtured to allow proper alignment with the engine cylinder. Braze paste can be manually applied to each of these parts in some embodiments. Visual post-braze inspection will insure that proper wetting of the alloy has occurred.

Any suitable braze alloy can be used to braze the heater head components together. The braze alloy can be, for example, a copper, Nicrobraz® 51, or gold-based alloy. Copper is particularly suitable as a braze alloy, as it can be used in the form of a clad sheet, which avoids the expense of placing braze alloy pre-forms between the plates of the hot heat exchanger.

The use of headings and sections in the application is not meant to limit the invention; each section can apply to any aspect, embodiment, or feature of the invention.

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise. As used herein, the term “about” refers to a ±10% variation from the nominal value.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the invention as if each value were specifically enumerated herein. In addition, smaller ranges between and including the upper and lower limits of a given range are contemplated and encompassed within the invention. The listing of exemplary values or ranges is not a disclaimer of other values or ranges between and including the upper and lower limits of a given range.

In the description, the invention is discussed in the context of solar concentrators; however, these embodiments are not intended to be limiting and those skilled in the art will appreciate that the invention can also be used with other energy converters.

The aspects, embodiments, features, and examples of the invention are to be considered illustrative in all respects and are not intended to limit the invention, the scope of which is defined only by the claims. Other embodiments, modifications, and usages will be apparent to those skilled in the art without departing from the spirit and scope of the claimed invention.

What is claimed is:

1. A heater head comprising:
a heat absorber plate forming a substantially concave surface; and
a manifold comprising a headwall for engaging a heat engine, the manifold forming a concave depression for receiving the heat absorber plate, the manifold forming a plurality of fluid channels to carry fluid between the heat absorber plate and the heat engine.

2. The heater head of claim 1 wherein the heat absorber plate has an arc or radius of between about 1× the outside diameter of regenerator to an infinite spherical radius.

3. The heater head of claim 1 wherein the heater head is configured for use with a solar concentrator, and whereby solar rays reflected by the solar concentrator impinge on the surface of the concave heat absorber plate at near right angles.

4. The heater head of claim 3 wherein a shape of the concave surface is configured such that compressive forces applied to the heat absorber plate caused by thermal loading are distributed by the concave shape of the heat absorber plate.

5. The heater head of claim 4 wherein the heater head plate has a thickness that ranges from about 0.040 inches to about 0.160 inches.

6. A solar energy converting apparatus comprising:
a Stirling engine comprising one or more pistons and a working fluid; and
a heater head having a substantially concave heat receiving surface, the heater head sized to receive light from a concentrator, wherein the heater head is in thermal communication with the Stirling engine.

7. The solar energy converting apparatus of claim 6 further comprising a plurality of channels disposed opposite to the concave heat receiving surface and a regenerator disposed proximal to and in fluid communication with the channels.

8. The solar energy converting apparatus of claim 7 wherein the channels are defined by a manifold, wherein the channels conduct the working fluid between the heater head and the Stirling engine to transfer heat and cause one or more pistons to travel.

9. The solar energy converting apparatus of claim 8 wherein the heater head has a bowl-shape that is configured to radially distributes compressive stresses resulting from thermal transitions.

10. A solar energy converting apparatus comprising:
a concave metal bowl having a curved heat receiving surface and a curved internal surface; and
a heater head wall defining a working fluid receiving cavity and a plurality of channels, the channels disposed adjacent to the curved internal surface, the heater head wall having a curved wall surface adjacent the curved internal surface.

11. The solar energy converting apparatus of claim 10 further comprising:
a regenerator disposed within the cavity, wherein the regenerator is porous such that a working fluid can flow through the regenerator into the plurality of channels.

12. The solar energy converting apparatus of claim 10 wherein the curved wall surface defines a manifold defining lengths of the plurality of channels such that the lengths are substantially perpendicular to a portion of the curved wall surface.

13. The solar energy converting apparatus of claim 12 wherein the plurality of fluid channels are configured to carry fluid between the heater head wall and a heat receiving element.

14. A method of extending the life of a heater head in a solar energy converting apparatus, the method comprising the steps of:
reducing a plurality of failure modes by sizing a heater head relative to a concentrator; and
selecting a concave heater head shape such that the concentrator has a convex shape relative to the heater head.

15. The method of claim 14 further comprising the step of positioning the concentrator relative to the concave heater head such that heat losses are reduced due to alignment errors.

16. The method of claim 15 further comprising the step of transferring heat to a working fluid in thermal communication with the heater head.

17. The method of claim 15 further comprising the step of radially distributing compressive stresses in the heater head resulting from thermal transitions.

18. The method of claim 15 further comprising the step aligning the concentrator and the heater head such that solar rays reflected by the concentrator impinge on a surface of the heater head.

19. The method of claim 15 wherein one of the plurality of failure modes is creep fatigue.

20. The method of claim 19 wherein one of the plurality of failure modes is metal fatigue.
